(19) United States
(12) Patent Application Publication
(10) Pub. No.: US 2021/0140213 A1
(43) Pub. Date: May 13, 2021

(54) PANEL DOOR LOCKABLE HINGE SYSTEM AND METHOD

(71) Applicant: Reggie L Bolden, Las Vegas, NV (US)

(72) Inventor: Reggie L Bolden, Las Vegas, NV (US)

(21) Appl. No.: 17/096,882

(22) Filed: Nov. 12, 2020

Related U.S. Application Data
(60) Provisional application No. 62/934,413, filed on Nov. 12, 2019.

(51) Int. Cl. E05D 7/10

(52) U.S. Cl. CPC E05D 7/1061; E05D 3/00

(57) ABSTRACT

A lockable door panel hinge and method of operation, the lockable door panel hinge comprising a first hinge plate and a second hinge plate that are configured to be removably connected to each other by a lock mechanism formed by the second hinge plate; the first hinge plate further defines a pivot mechanism that bifurcates the first hinge plate into a first support plate and a second support plate, the first support plate and a second support plate are pivotally connected to another by the pivot mechanism; and the first hinge plate is further configured to attach to a first door panel of a panel door while the second hinge plate is further configured to attach to second door panel of a panel door to removably hold the first door panel pivotally adjacent to the second door panel and to allow both panels to pivot about the pivoting mechanism.

### CROSS-REFERENCES TO RELATED APPLICATIONS

The Applicant claims priority to and incorporates by reference herein of the contents of the U.S. Provisional Patent Application entitled PANEL DOOR LOCKABLE HINGE SYSTEM AND METHOD, Ser. No. 62/934,413, filing date Nov. 12, 2019.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention may relate to a lockable hinge comprising multiple hinge plates that are removably locked together, the lockable hinges are generally used to removably connect adjacent door panels together to form a railing-mounted panel door. More particularly to those lockable hinges that can be further released apart to separated hinge plates to allow adjacent door panels forming a railing mounted door panel to also be separated from one another while being generally movably connected to said railing.

### BACKGROUND

A railing-mounted panel door, such as the door types that are used for many garages, may comprise several door panels movably hinged together along their adjacent longitudinal edges. In one panel door version, the lateral ends of each such door panel (e.g., panel door sides) may be movably attached by wheel rollers to a respective railing from a set (e.g., a pair) of spaced-apart railings that generally straddle an opening to which the panel door movably controls ingress and egress. The railings in one such embodiment may have a J-shaped cross section, each railing further demarcated into a curved railing portion that continuously connects a vertical oriented portion (e.g., located proximate to the opening controlled by the panel door) to a horizontal oriented portion (e.g., that one horizontal oriented portion end is located proximate the top of the opening, the remaining of the horizontal oriented portion projects outward and away from the opening to locate the remaining horizontal oriented portion end distal from the top of the opening.)

The panel door may move along the railing pair between a vertical (e.g., closed) door position and a horizontal (e.g., open) door position to control the opening egress and ingress. A counterbalancing or counterweight apparatus may be connected to the bottom door panel to counter balance or offset the panel door weight while a motorized unit may connect to the top door panel to power the panel door along the railing set between the horizontal-open and vertical-closed positions.

Another version of a garage panel door may be horizontally suspended from a railing. Each door panel of this panel door may have one set of the panel lateral ends forming one door end, the one door end may be movably suspended from the horizontally suspended railing. In this embodiment, the panel door may move along the horizontally suspended railing to cover and uncover (e.g., move between vertical open and closed positions) an opening that is proximate to at least a portion of the horizontally suspended railing (e.g., the opening is located proximate to one end of the horizontally suspended railing.)

The door panels may be pivotally connected by panel hinges attached to adjacent door panel longitudinal edges together in a manner that allows each individual door panel to transition between vertical and horizontal door positions during panel door movement along the railing set. Each panel hinge could comprise a first hinge plate pivotally connected to a second hinge plate. A pivotal connecting device, such as a pin, rod, tube or alike, may moveably and permanently connect overlapping portions of the first and second hinge plates to create a pivot mechanism that provides the folding action of the panel hinge.

For those panel hinges located at the door panel lateral ends (e.g., door sides), the pivotal connecting device may be hollow to continuously connect together multiple pin apertures formed by the hinge plates to generally create a double open-ended pin channel. This channel that may removably receive and rotatably hold an axle of a wheel roller (e.g., a wheel with a centerline axle or stem attached to and projecting outward from the center of one side of the wheel) to allow the wheel of the wheel roller to be movably received within a respective railing of the railing set. For those wheeled hinges located further higher up on the panel door, the panel hinge may further support a secondary non-hinging double open-ended hollow pin or tube held away from the respective hinge plates to receive the axle. Generally, only those hinges proximate to panel lateral ends (e.g., door sides) are fitted with wheel rollers while those hinges distal to the panel ends and railings (e.g., in the panel door midsection) are generally not fitted with wheel rollers.

In addition to panel hinges, wheel roller holders may be applied to panel door's top and bottom longitudinal edges proximate (proximate to respective panel lateral ends) to rotatably hold the wheel roller in movable engagement with a respective railing. The wheels of the wheel rollers may be pivotally inserted into a respective railing to connect a lateral end of the door panel to the railing.

These wheel roller holders generally lack any hinge mechanism. The bottom located wheel roller holder substantially holds the wheel roller close to the bottom door panel. The top located wheel roller holder generally holds the wheel roller up and away from the top door panel to substantially facilitate the top door panel's navigation of the curved portion of the railing set and to further close the top edge with the respective opening when the panel door is in the vertical or closed door position.

Each railing of the railing set could have a J-shaped cross-section having a covered lip section and opposing flat lip section. Once the wheel is inserted into a respective railing generally rides along the curved lip section of the railing while the opposing flat lip section of the railing generally prevents the wheel from leaving contact with the curved lip portion during panel door's movement along the railing(s).

Generally, the panel door assembly is accomplished by taking one door panel of a set of door panels and movable attaching that door panel one at time to the railing. As each door panel is movably attached to the railing set, a set of several hinges could be used to pivotally connect two adjacent door panels along respective adjacent panel longitudinal edges. The hinge's first hinge plate could attach to a second or upper door panel while the second hinge plate could attach to the adjacent lower or first door panel. In this manner, a set of several hinges could be applied to movably connect two adjacent door panels together.

The first or bottom door panel to be attached to the railing set may further comprise a set of hinges and a set of wheel roller holders. One-wheel roller holder could be attached on first door panel's bottom longitudinal edge (e.g., proximate to the door panel's right lateral end.) A wheeled hinge may be attached at the first door panel's top longitudinal edge (e.g., again by the door panel's right lateral end.) Non-wheeled hinged hinges may then be connected along the first door panel's top longitudinal edge distal from the respective panel lateral ends. A wheeled hinge and wheel roller holder to be located on the other (e.g., left side) panel lateral end could be temporarily left off from the first door panel at this time.

Next, the bottom door panel could be pivoted about its right lateral edge right to allow the ride side attached wheel rollers to movably engage the right railing of the railing set. The remaining roller holder and remaining wheeled hinge could be attached to the first door panel's left panel lateral end in a manner to movably insert those respective wheels of the wheel roller holder and wheeled hinge into the remaining railing (e.g., left railing) of the railing set to movable secure the first or bottom door panel to the railing set. A set of non-wheeled hinges may also be attached to the first panel's top longitudinal edge but distal to the first panel's lateral ends.

A second panel, or next panel to be attached to the railing set could further comprise a set of wheeled hinges and a set of non-wheeled hinges that are to be attached to the second panel's top longitudinal edge. One wheeled hinge could be attached to the second panel's top longitudinal edge proximate to the second panel's right lateral edge. The second panel could then be pivoted about the right railing to insert wheel of the one (e.g., right side) wheeled hinge into the right railing allowing the second panel's bottom longitudinal edge to rest upon the first panel's top longitudinal edge.

After this right rail attachment is accomplished, the wheel of the second door panel's remaining wheel hinge could be pivoted into second (e.g., left railing) to align and allow the attachment of the remainder of the remaining (e.g., left) wheel hinge along the second door panel's longitudinal top edge proximate to the second door panel's second or left lateral panel edge.

In that second panel's lower longitudinal edge may now be adjacent to the first panel's top longitudinal edge, the wheeled hinges and non-wheeled hinges of the first panel may be secured to the second panel.

This panel door assembly process could be repeated to add the remaining door panels to complete the panel door that is movably attached to the railing set. Once the panel door is assembled and attached to the railing set, a counterweight system and motorized unit (for moving the panel door along the railing set) may be suitably anchored and then attached to the assembled panel door. This assembly process could be substantially reversed to generally disassemble the panel door; remove and replace individual door panels; and the like.

Generally, the hinges used in the assembly of such panel doors may comprise of hinge plates permanently pivotally attached to one another. This hinge construction, which generally does not allow for separation of the joined hinge plates could hamper or otherwise impair the speed and safety of panel door assembly and disassembly (e.g., how well such panel doors can be connected to and disconnected from a railing set.) In that such hinge construction generally supports only one wheel per wheeled hinge, the removal of such wheel hinges from an upper door panel to release the upper door panel from the railing set, could allow the previously secured adjacent lower door panel to fall downward upon the remaining section of the panel door. The adjacent lower door panel's movement in such a situation could cause possible injury to the person working on the panel door or at the very least place the adjacent lower door panel in an awkward position for reattachment to or support of an adjacent upper panel.

One possible solution to making panel door assembly, disassembly, in-situ repair and alike safer, easier, simpler could be the present invention generally utilizing a lockable hinge comprising a pair of hinge plates that are removably connected together for quick and easy connection and separation of door panels comprising a panel door wherein each hinge plate separately supports a wheel roller. Another version of the lockable hinge could further comprise of a hinge pivoting mechanism that is only formed by one hinge plate of the hinge plate pair (e.g., the hinge plates are not directly connected together by a pivot mechanism.)

The first hinge plate of the invention could comprise a first support plate and a second support plate that are permanently and movably connected by a pivoting mechanism that allows the first and second hinge plate to pivot about each other respectively and to provide the hinge motion for the lockable hinge itself. The first support plate and hence the first hinge plate, for the panel lateral end lockable hinge embodiment, could supported first wheel roller. The second hinge plate, for the panel lateral end lockable hinge embodiment, could support a second wheel roller. In this manner, each panel door could have its own set (rather than have a shared set) of four wheel rollers with a wheel roller anchored at each corner of a respective door panel for connecting the door panel to the railing set. This lockable hinge setup could allow one door panel be removed or attached to a respective railing set and adjacent door panels without affecting the wheel roller attachment of the remaining door panels to railing set. This lockable hinge attachment could otherwise prevent a flop down of an adjacent lower door panel that is not currently being removed from the railing set. This flop down prevention could lead to easier panel door construction and disassembly as well as possibly prevent panel door damage and operator personal injury.

The two hinges plates could form a latch-based locking mechanism for removably connect the two hinge plates together pivotally and removably connect adjacent door panels together. The locking mechanism in one version of the invention could have a second support extending outward a catch plate with lateral ridge(s). The catch plate could then removably interact with a latch mechanism that is otherwise defined by the second hinge plate. In one possible embodiment, the latch mechanism may comprise a pivoting latch plate combined with a ratchet, the combination moving between a first or open latch plate position for generally releasing the catch plate and a second or closed latch plate position that can generally engage the catch plate.

The first hinge plate can be attached to one top door panel while the second hinge plate cane be attached to another adjacent lower door panel so that when two door panels are brought together, the respective hinge plates of a lockable hinge can also be brought together to “clicked” connected (e.g., the first hinge plate's latch plate may be removably received within the second hinge plate's latching mechanism.) Similarly, the locking mechanisms of the lockable hinges located between the two adjacent door panels can be disengaged (e.g., placed in first or open latch plate position) to substantially allow one door panel to be easily and safely be disconnected from an adjacent door panel while at the same time allowing the adjacent door panel to remain fully connected by wheel rollers to the railing set.

### SUMMARY OF ONE EMBODIMENT OF THE INVENTION

### Advantages of One or More Embodiments of the Present Invention

The various embodiments of the present invention may, but do not necessarily, achieve one or more of the following advantages:

to provide a door panel attachment system for a panel door that allows easy and safe attachment and detachment of the door panels from one another;

the ability of a door panel attachment system to allow easy and safe attachment and detachment of the door panels from a railing set;

to provide a panel door system that holds one door panel fully in place and engaged to a railing set while fully removing the adjacent door panel from the railing set and adjacent door panels;

the ability of a lockable panel door hinge to separate into hinge plates to ease the removal and attachment of door panel(s) comprising a panel door from a railing set;

to provide a panel door hinge that may be used to support multiple wheel rollers to ease assembly or disassembly of a panel door engaged to a railing set;

the ability of a lockable panel door hinge that separates into hinge plates, wherein a pivoting mechanism is found only on one hinge plate and not used to removably connect the respective hinge plates together;

to provide a panel door hinge that separates into hinge plates, wherein each hinge plate supports its own wheel roller that could support a respective door panel;

the ability of a panel door lockable hinge to support multiple wheel rollers to ease attachment or removal of a door panel engaged to a railing set to form a panel door; and

provide a lockable panel door hinge comprising two hinge plates removably connected by a locking mechanism wherein each hinge plate supports a separate wheel roller.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a lockable door panel hinge comprising: a first hinge plate and a second hinge plate that are configured to be removably connected to each other by a lock mechanism formed by the second hinge plate; the first hinge plate further defines a pivot mechanism that bifurcates the first hinge plate into a first support plate and a second support plate, the first support plate and a second support plate are pivotally connected to another by the pivot mechanism; and the first hinge plate is further configured to attach to a first door panel of a panel door while the second hinge plate is further configured to attach to second door panel of a panel door to removably hold the first door panel pivotally adjacent to the second door panel and to allow both panels to pivot about the pivoting mechanism.

Another possible embodiment of the invention could be a method or process for operating operation for a lockable panel door hinge comprising the following steps: providing a plurality of door panels that are configured to form a panel door, wherein a respective door panel pivots about an adjacent door panel; providing a set of lockable door panel hinges, each lockable door panel hinge comprising a first hinge plate and a second hinge plate, the two hinge plates further configured to be removably connected together by a lock mechanism, the first hinge plate further forming a pivot mechanism that bifurcates the first hinge plate into a first support plate and a second support plate, the first support plate and second support plate pivoting about the pivot mechanism, the lock mechanism and pivoting mechanism being separate mechanisms; connecting the first hinge plate to one door panel of the plurality of door panel; connecting the second hinge plate to another door panel of the plurality of door panels; and activating the lock mechanism to removably connect the first hinge plate to the second hinge plate and pivotally connect the respective door panel to the adjacent door panel.

Yet another possible embodiment of the invention could a system of pivotally connected door panels that form a panel door comprising: a plurality of door panels that are configured to form a panel door, wherein a respective door panel pivots about an adjacent door panel; a set of lockable door panel hinges, each lockable door panel hinge comprising a first hinge plate and a second hinge plate, the two hinge plates further configured to be removably connected together by a lock mechanism, the first hinge plate further forming a pivot mechanism that bifurcates the first hinge plate into a first support plate and a second support plate, the first support plate and second support plate pivoting about the pivot mechanism, the lock mechanism and pivoting mechanism being separate mechanisms; wherein a first hinge plate attaches to the respective door panel and the second hinge plate attaches to the adjacent door panel, the second support plate removable engages the lock mechanism so that the respective door panel and the adjacent door panel pivots about each other and the pivot mechanism.

The above description sets forth, rather broadly, a summary of one embodiment of the present invention so that the detailed description that follows may be better understood and contributions of the present invention to the art may be better appreciated. Some of the embodiments of the present invention may not include all the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a top view of one embodiment of the present invention in general showing the lockable hinge in an unconnected state.

FIG. 2 is substantially a left elevation view of one embodiment of the present invention in general showing the lockable hinge in an unconnected state.

FIG. 3 is substantially a right-side elevation view of one embodiment of the present invention in general showing the lockable hinge in an unconnected state.

FIG. 4 is substantially a top view of one embodiment of the present invention in general showing the lockable hinge in a connected state.

FIG. 5 is substantially a perspective back edge view of one embodiment of the present invention in general showing the lockable hinge in a connected state.

FIG. 6 is substantially a right-side elevation view of one embodiment of the present invention in general in showing the lockable hinge in a connected state.

FIG. 7 is substantially a perspective back edge view of one embodiment of the present invention in general showing the second hinge plate without a wheel roller.

FIG. 8 is substantially a perspective exploded view of one embodiment of the present invention in general in showing the second hinge plate without a wheel roller.

FIG. 9 is substantially a cutaway view of one embodiment of the present invention in general showing an exploded view of the lever-based latch opening mechanism and ratchet-based latch holding mechanism.

FIG. 10 is a schematic flowchart showing one possible embodiment of a process or method for operating the invention.

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized, and structural changes may be made, without departing from the scope of the present invention.

As shown in FIGS. 1-9, the present invention 10 could be panel door lockable hinge 30 and a method or process 200 for operating said lockable hinge 30. The lockable hinge 30 could be configured to pivotally and removably attached multiple door panels 12 together to form a panel door 14. The panel door 14 could be configured to attach to and move along at least one railing (not shown) to alternately cover and uncover an opening (not shown) proximate the at least one railing (not shown) to that generally control ingress into or egress from a building structure (not shown.)

In one possible embodiment, the formed panel door 14 is generally located between a set of spaced-apart railings (e.g., a pair of railings) (not shown) mounted to the building structure (also not shown) proximate to the opening generally denoted by the building structure. Those lockable hinges 30 that could be located proximate to the lateral panel ends 16 of the door panels 12 may further support a set of wheel rollers 36. The wheel rollers set 36 may be used to movably attach a respective lateral panel end 16 to a respective railing of the spaced-part railing pair (not shown) This door panel attachment may place the door panel 12 between the spaced-part railing pair in a manner wherein each corner of the door panel 12 has its own respective wheel roller 36 movably attached to a railing (not shown.)

The wheel rollers 36 could comprise an axle or stem 40 that may extend outward from the center of one side of a wheel 38 (e.g., the axle or stem 40 generally being perpendicular to the plane in which the wheel may lay). The wheel rollers 36 could allow the formed panel door 14 to generally move along the length of the railing set (not shown) while the pivoting action of the lockable hinges 30. The wheel rollers 36 could allow the door panels 12 to transverse between a first or closed door position (e.g., a vertical orientation of the panel door that generally allows the panel door to be brought close or proximate to the opening to substantially prevent passage through the said opening) to a second or open door position (e.g., vertical orientation of the panel door that stores the panel door generally above and distal from the opening allowing passage through the opening) of the railing set (not shown.)

The lockable hinge 30 may comprise a first hinge plate 32 and second hinge plate 34 that are removably connected together by a lock mechanism 42 comprising a catch plate 51 and a latch mechanism 66. The first hinge plate 32 could further comprise a first support plate 44 that permanently and pivotally attaches to a second support plate 46 that are attached together. In operation, the first support plate 44 could be configured to be attached near the bottom longitudinal edge 19 of a second or upper door panel 26 to allow the second support plate 46 to pivotally drape down and over the top longitudinal edge 18 of lower or first door panel 24 (e.g., placing permanent pivot of the first hinge plate 32 proximate between adjacent longitudinal edges 18, 19 of the first and second doors panels 24, 26.) This draping action could allow the second support plate to removably engaged the second hinge plate 34 as attached to the lower or first door panel 24 by the lower panel's top longitudinal edge 18. It should be noted that the hinge plate positions could be reversed on the first and second door panels 24, 26 but such positioning may make it harder to move the second support plate 46 (e.g., catch plate 51) into position to movably engage the second hinge plate 34 (e.g., the second support plate 46 would drape down and over the first support plate 44 instead of the second hinge plate 34.)

The first support plate 44 could further configure a base plate 45 whose sides form a first arm set 43 (e.g., a first arm pair) projecting upward from the base plate 45 and being located proximate to the non-hinge end of the first support plate 44. The first arms 43 could be spaced apart from one another in a parallel orientation to one another. For lockable hinges 30 (that are generally are located proximate to the respective door panel's lateral panel ends 15) both first arms 43 could be further penetrated by a set of aligned roller support apertures 47 to movable support a wheel roller axle 40 in a fashion to allow the wheel 38 of the wheel roller 36 to movably engage a railing (not shown.) In one embodiment of the invention, a first double-open ended hollow tube 48 could continuously connect the aligned roller support apertures 47 to create a roller channel 50 that substantially supports a wheel roller 36 as supported by the first arm pair 43. The first arm set 43 could further define a set of first pivot apertures 52 that are projected over first hinge plate's hinge edge.

The second support plate 40 could similarly form a second set of support arms 54 that form a second set of hinge apertures 56 that project out over the hinge end of the second support plate 40. The first and second support plates 44, 46 could be brought together to allow the first hinge aperture set 52 and second hinge aperture set 56 to overlap and align with one another. Once the first and second hinge aperture sets 52, 56 are aligned, a pivot bar or tube 58 could movably pass into and be permanently held in place within the first and second hinge aperture sets 52, 56 to substantially form a pivot mechanism 61 (e.g., the first support plates 44, the second support plates 46 or both could pivot about the pivot bar 58.) The hinge mechanism 61 could permanently and pivotally link the first and second support plates 44, 46 together to substantially form the first hinge plate 32.

The second support plate's non-hinge end could act as the catch plate 51 that has one or more spaced apart and laterally disposed ridges 49. The catch plate 51, as part of the lock mechanism 42, could removably engage the latch plate 70 of the second hinge plate's latch mechanism 66 to removably connect the first and second hinge plates 32, 34 directly together to generally assemble the lockable hinge 30.

The second hinge plate 34 (e.g., that may be placed proximate to a panel lateral end 16) could further configure a third support arm set 60 (e.g., a third support arm pair) and a set of latch support arms 64 (located at the other end of second hinge plate.) Each third support arm 60 could be located proximate to the second hinge plate's first end (the first end being located proximate to the first hinge plate 32.) Each third support arm 60 could be perpendicularly project upward from a respective side of the second hinge plate 34 in a parallel and spaced apart fashion to one another. Each third support arm 60 could denote a second roller support aperture 62 to movable support a stem or axle 40 of another wheel roller 36 in a fashion that allows the wheel 39 of said wheel roller 36 to engage a railing of the railing set (not shown.) Another double-open ended hollow tube 48 could continuously connect the another set of roller support apertures 47 together to form another roller channel 50 to movably receive and support said another wheel roller 36.

The second hinge plate's latch support arms set 64 could support the latch mechanism 66. The latch mechanism 66 could comprise a latch plate 70, lever lift mechanism 72, and ratchet securing device 74. The latch plate 70 could form two sets of spaced-apart latch arms with a latch arm set located at respective end of the latch plate 70. The first set of latch arms 76 may form a pair of latch apertures that could hold a support bar 80 that could help form and support a grasping handle end 82. The other set of latch arms 78 (e.g., generally denoting the latch plate's pivot end) could configure a set of pin apertures that fixedly receive a latch plate pin 84 (e.g., the latch plate 70 generally would not revolve about the latch plate pin 84.) The latch plate pin 84 could further form a lengthwise open-sided channel 86 that could allow removable engagement of the latch plate pin 84 by the ratchet securing device 74. The latch plate pin 84 could be pivotally and movably be held by the latch support arms apertures in the latch support arms set 64 to generally allow the latch plate 70 to move between a first or open latch plate position for generally receiving or releasing the catch plate 51 and a second or closed latch plate position for generally engaging the catch plate 51. The latch plate 70 could be biased (e.g., by a spring-not shown-located proximate to the latch plate pin 84) to substantially move the grasping handle end towards the second hinge plate 34 (e.g., to the second or closed latch plate position.)

The ratchet securing device 74 could comprise a ratchet 88, a support wall 90 and a latch lever 92. The ratchet 88 could comprise a ratchet lever 94 perpendicularly penetrated at one end by a release rod 96. The ratchet lever 94 could segment the release rod 96 into manual release (e.g., the manual portion being lifted by the operator's finger to pivot the ratchet 88 out of engagement with the latch plate pin's open-sided channel 86) and automatic release portions 98, 100. Proximate to the release rod 96, the ratchet lever 94 could form a ratchet lever aperture that could movably accommodate a pivot stud that projects outward from the support wall 90 to allow pivoting attachment of the ratchet 88 relative to the support wall 90. The remaining end of the ratchet lever 94 could project a tooth 104 (e.g., wedged-shaped) that could removably engage the pivot bar's open-sided channel 86 to hold the latch plate 70 in the first or open position to generally allow the latch mechanism 66 to generally release or receive) first hinge plate 32 and respective ridge(s) 49. The ratchet 88 could be torsion or spring-biased in relation to the support wall 90 or the like to removably engage the open-sided channel 86 of the latch plate pin 84.

The support wall 90 could be a rectangular plate that may be located and secured proximate to a side of the second hinge plate 34. At one end for the support wall 90 could be a rectangular aperture 106 that can accommodate within the passage and movement of the manual release portion 98. The support wall's other end could form a pin end aperture through which one end of latch plate pin could movably pass to fixedly connect to the latch lever 92.

The latch lever 92 could be a cylindrically-shaped bar generally denoting a handle portion at one latch lever end and a pin cup 108 projecting out from the side of the latch lever 92 proximate to the other latch lever end. The pin cup 108 could further form an index pin 110 that snuggly fits into the open-ended channel 86 of an end of the latch plate pin 84. The index pin 110 further secures the latch lever 92 to the latch plate pin 84 to prevent the latch lever 92 from revolving about the latch plate pin. This index pin attachment could ensure that a movement of the latch lever 92 generally rotates the latch plate pin 84 and attached latch plate 51 together relative to the remainder of the latch mechanism 66. This index pin configuration could allow for the rotational movement of the latch lever 92 to pivotally move the latch plate 70 between the first or open latch plate position (e.g., generally allowing latch plate 70 engagement or disengagement from the second hinge plate 34/catch plate 51 and allowing the ratchet securing device 74 to engage and hold open the latch plate 70) and the second or closed latch plate position (e.g., substantially bringing the latch plate grasping handle end 82 proximate to the second hinge plate 34 to generally allow the latch mechanism 66 to removably engage the catch plate 51.)

When the first hinge's catch plate 51 engages the second hinge's latch mechanism 66 by moving in between the latch plate 70 and the second hinge plate 34, the catch plate 51 generally engages and lifts the automatic release portion 100 up and away from second hinge plate 34. This lifting motion may pivot the ratchet lever 94 to generally move the tooth 104 out of contact with the latch plate pin's open-sided channel 86. As the tooth 104 moves out of contact, the pulled back latch plate 70 may be released from the ratchet 88. These actions generally allow the biased latch plate 70 to then rotate about to bring the grasping handle end 82 towards catch plate 51 (e.g., first hinge plate.) The leading edge of the latch plate 70 may then close down upon and removably engage at least one ridge 49 of the catch plate 51 to removably connect the first and second hinge plates 32, 34 together to assemble the lockable hinge 30.

In at least one embodiment of the invention, a securing cup 112 (e.g., a section of a hat channel) can be removably attached (e.g., by fasteners) to the second hinge plate 34 (e.g., when the lock mechanism 42 is in the second or closed latch plate position and engaging the second support plate 46/catch latch 51 to form the lockable hinge 30 to generally prevent an accidental release of the second support plate 46/catch plate 51 from the second hinge plate 34 by an unwanted rotation of the latch lever 92 or other similar actions during panel door operations.

To release the catch plate (e.g., unlock the hinge plates from one another), the securing cup 112 may be removed from the second hinge plate 34 to expose the latch mechanism 66. The latch plate 70 may be directly moved to the first or open hinge position by generally grasping and lifting the grasping handle end 82. The latch plate 70 may be also moved in an indirect manner to the first or open hinge position by grasping and rotating the latch lever 92. Either action may move the latch plate 70 against under bias or tension (e.g., by suitable spring, not shown) clear of the previously engaged catch plate.

A non-hinge wheel roller mount (not shown) for the top and bottom door panels 24, 26 may attach proximate to panel lateral ends on the top longitudinal edge (e.g., for the top door panel) and bottom longitudinal edge (e.g., for the bottom panel.) The non-hinge wheel roller mount may be used instead of wheeled lockable hinges for the top and bottom (e.g., terminal end) door panels, in that top and door panels are not further attached to additional door panels. The non-hinge wheel roller mount could comprise a mount plate having a set of support ears raising up from each side of the mount plate in spaced-apart and parallel orientation to one another. Each support ear could have a respective wheel aperture, with each wheel aperture being continuously connected by a double open-ended support tube. The double open-ended support tube can movably receive and support an axle of a wheel roller to allow the non-hinge wheel roller mount to use the wheel roller to movably engage a respective railing. The non-hinge wheel roller mount could be attached to their respective door panel by suitable fasteners.

One possible method or process 200 for generally operating the lockable hinge could start with step 202, the preliminary assembling of the panel door parts. In this step, the unassembled panel door could come as a kit including hardware, hinges, door panels, counterweight system (e.g. coil spring[s]), motor unit (e.g., electrical door drive system), a set of railings, assembly instructions and the like. The set or pair of railings could be installed to the building structure in relation to an opening through the invention could control egress and ingress to the building structure or part(s) thereof. In one embodiment, the railings of the railing set can be L-shaped and straddle the opening in parallel orientation to the other railing wherein the foot-portion of the railings being generally located vertically adjacent to the opening. The other leg-portions of the railings could be in a horizontal orientation and moving away from the top of the opening with a horizontal railing end being distal from the opening.

A motor drive system may be generally used to move the assembled panel door between open and closed door positions. The motor drive system can be located proximate to the railing set, generally between the horizontal portions of the railing set. A counterweight system, generally one or more coil springs located by the opening top (e.g., opening lintel) that can be tensioned and impart their load, generally by cable or the like, to the assembled panel door to reduce the moving weight footprint of the panel door thus generally reducing the motor drive system's required capability to raise and lowered the assembled panel door in controlled manner. When the motor drive system is momentarily disconnected from the assembled door panel, the counterweight system also allows an operator to manually move the assembled panel door between open and closed door positions.

Several door panels could be brought proximate to the assembled railing set. One possible invention embodiment could have respective hinge plates previously attached to door panels (e.g., by the factory) with the exception of those wheeled hinge plates that are to be attached proximate to the left lateral panel ends. The top door panel and bottom panel may further have respective (e.g., right side) wheel roller mounts attached to the right-side lateral panel ends at this time. Upon the substantial completion of this step, the process could proceed to step 204, attaching door panel to the railing set.

In step 204, attaching a door panel to the railing set, one door panel (e.g., the first or bottom door panel) can be brought proximate to the railing set. The first door panel's other panel lateral end (left side) could be lacking respective wheeled hinge plate(s) and the non-hinged wheel roller mount at this time. The right door panel lateral side end could be brought over to one railing (e.g., right side railing) and the wheels of the respective right side wheeled hinge plate(s) and the non-hinged wheel roller mount could be pivoted into the one (e.g., right) railing. The other panel lateral end (e.g., left side) then could be brought over to the left railing. The wheels of the left side wheeled hinge plate and left wheel mount could be pivoted into the left railing. As these left side wheel rollers are being engaged with the one (e.g., left) railing, the other panel lateral (e.g., left) side may be swung over to the other (e.g., left) railing. The left wheel rollers could be inserted into the respective left side wheeled hinge plate(s) and left side non-hinge wheel roller mount. After this wheel roller insertion, the left side wheeled hinge plate(s) and left side non-hinge wheel roller mount could be fastened to the first door panel (e.g., by the bottom door panel's longitudinal edges proximate to the other [left] side lateral panel edge) to complete the movable attachment of one or bottom door panel to the railing set. Non-wheel hinge plates can be attached to the bottom door panel's top longitudinal edge, distal from the panel lateral ends.

One or more spacer blocks can be put on top of the upper or top longitudinal edge of the first or bottom door panel to removably engage the subsequent door panel being placed adjacent (e.g., directly above) the first door panel to hold the two respective door panels apart. This spacing could allow for proper hinge plate attachment and proper wheel roller-railing engagement for the next (e.g., second) door panel. As this step is substantially completed, the process 200 could proceed to the step 206, attaching another door panel.

At this time in step 206, attaching another door panel, the next or second door panel in sequence in the formation of the panel door can be brought over to the railing set. The door panel-to-railing set attachment sequence as described in step 204 can be generally followed to provide subsequent door panel attachment to railing set: attaching the right wheel roller hinge plates to one (e.g., right side) lateral panel end of the next (e.g., second) door panel; bringing the other (e.g., right) lateral panel end over to the one (e.g., right) railing; engaging the right wheel rollers with the right railing. The second door panel can then be rested upon the spacer block(s) to hold the first and second door panels in a spaced-apart orientation as the wheel rollers of the (left side) wheeled hinge plates are movably engaged with the other (e.g., left) railing. After suitable wheel roller-railing engagement, the respective (left side) wheeled hinge plates may be attached to the second door panel's longitudinal edges proximate to the other (e.g., left) panel lateral end. The non-wheeled hinge plates may be attached to the next (e.g., second) door panel's longitudinal edges distal to the panel lateral ends.

In this manner, the top longitudinal edge of the first door panel could support a set of second hinge plates that could connect with the set of first hinge plates supported by the bottom longitudinal edge of the other or second door panel to assemble the lockable hinges holding the two door panels in a pivotal relationship. The top longitudinal edge of the second door panel could support a set of second hinge plates that could engage the first hinge plate set of yet another door panel that could be next the panel door in the assembly. At this time, the railing set could be holding the first and second door panels in a vertical and planar orientation to one and other.

Once the appropriate wheel roller engagements and hinge plate attachments have occurred for the second door panel, the latch plates of appropriate latch mechanisms can be grasped at the grasping handle end or by the latch lever to move the respective latch plate from the second or closed latch plate position to the first or open latch plate position. As the latch pates are moved to the first or open latch plate position, the respective ratchets can engage the open-sided channel of respective latch plate pins to hold the latch plates in the first or open latch plate position. Once the latch plates are set at the first or open latch plate position, the respective second hinge plate latch mechanisms (of the first door panel) are to ready to receive the catch plates of the respective first hinge plates (of the second door panel.) Once this step is substantially completed, the process 200 can proceed to step 208, connecting the adjacent door panels together.

At step 208, connecting the adjacent door panels together, the next or second door panel could be lifted off of the spacer block(s) to allow the spacer block(s) to be removed from between the first and second door panels. The second door panel could be lowered down onto upon the first door panel to allow the catch plates of the second support plates to be delivered into the latch mechanisms of respective second hinge plates to lift the automatic release portions. Lifting the automatic release portions could pivot the respective ratchets and cause the removal of the teeth from the latch plate pins (e.g., the open-sided channel.) The latch plates under tension or bias (e.g., that may be provided by a spring-not shown) could then rotate to the second or closed latch plate position to removably engage and hold the catch plates in place within the second hinge plates to allow the general coupling of the respective lockable hinges. A hat channel cover plates may be removably fastened over the latch mechanisms (e.g., the closed positioned latch plate) to prevent accidental lifting of the latch plate, disassociation of the first and second hinge plates with resulting separation of adjacent door panels.

The process 200 can return to step can be returned to step 206, attaching another door panel, to add in succession the remaining door panels and coupling hinge plates (e.g., assembling the lockable hinges) to pivotally hold the adjacent door panels together until the panel door is completed and movably attached to the railing set. The panel door could be dissembled into individual door panels using the reverse process. As needed, the door panel's latch plates (and an adjacent door panels latch plates) may have been placed in the open position to allow the release of the door panel from the adjacent door panel. The panel door to be removed can be held apart from adjacent panel doors by spacer blocks. Respective left wheel roller hinge plates could be disconnected from the left panel lateral edge to allow the left wheel rollers to be removed from the left railing. The panel door then can be lifted out from the adjacent door panel(s) to be pivoted out of right wheel roller contact with the right railing to remove the door panel from the railing system. Once the door panel is removed from the railing set, the manual portions can be lifted, releasing the ratchets, allowing the lever plates to rotate under bias or other suitable tension to the second or closed latch plate position to substantially prevent damage to the latch plate as the released door panel is otherwise moved or stored away from the remainder of the panel door or other door panels.

### CONCLUSION

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A lockable door panel hinge comprising:
(A) a first hinge plate and a second hinge plate that are configured to be removably connected to each other by a lock mechanism formed by the second hinge plate;
(B) the first hinge plate further defines a pivot mechanism that bifurcates the first hinge plate into a first support plate and a second support plate, the first support plate and a second support plate are pivotally connected to another; and
(C) the first hinge plate is further configured to attach to a first door panel of a panel door while the second hinge plate is further configured to attach to second door panel of a panel door to removably hold the first door panel pivotally adjacent to the second door panel and to allow both door panels to pivot about the pivoting mechanism.

2. The lockable door panel hinge of claim 1 further comprises a first wheeled roller supported by the first hinge plate and a second wheeled roller supported by second hinge plate, both the first and second wheeled rollers configured to movably engage a support railing.

3. The lockable door panel hinge of claim 1 wherein the first support plate is pivotally connected by the pivot mechanism to the second support plate.

4. The lockable door panel hinge of claim 3 wherein a one edge of the second support plate engages the pivoting mechanism while an opposing edge of the second support plate is configured to removably engage the lock mechanism.

5. The lockable door panel hinge of claim 4 wherein the opposing edge of the first support plate comprises one or more ridges that are removably engaged by the lock mechanism.

6. The lockable door panel hinge of claim 1 wherein a lock mechanism further comprises a securing device that removable engages a latch mechanism to hold the lock mechanism in a closed position.

7. The lockable door panel hinge of claim 6 wherein the securing device further comprises a ratchet that removably engages the latch mechanism in a closed position.

8. The lockable door panel hinge of claim 7 wherein a latch lever connects to the latch mechanism to move the latch mechanism between a closed and open positions by acting upon the ratchet.

9. The lockable door panel hinge of claim 1 further comprising a securing cap that removably covers a latch lever to prevent a deactivation of a securing device of the lock mechanism.

10. The lockable door panel hinge of claim 1 further comprising a securing cap that removably covers a latch plate of the lock mechanism to prevent a release of the first hinge plate from the second hinge plate.

11. A method for operating for a lockable panel door hinge comprising the following steps, but not necessarily in the order shown:
(A) providing a plurality of door panels that are configured to form a panel door, wherein a respective door panel pivots about an adjacent door panel;
(B) providing a set of lockable door panel hinges, each lockable door panel hinge comprising a first hinge plate and a second hinge plate, the two hinge plates further configured to be removably connected together by a lock mechanism formed by the second hinge plate, the first hinge plate further forming a pivot mechanism that bifurcates the first hinge plate into a first support plate and a second support plate, the first support plate and second support plate pivot about the pivot mechanism, the lock mechanism and pivoting mechanism being separate mechanisms;
(C) connecting the first hinge plate to one door panel of the plurality of door panels;
(D) connecting the second hinge plate to another door panel of the plurality of door panels; and
(E) activating the lock mechanism to removably connect the first hinge plate to the second hinge plate and pivotally connecting the one door panel to the another door panel.

12. The method of claim 11 further comprises of a step of bringing the one door panel adjacent to the other door panel.

13. The method of claim 12 wherein the step of bringing the one door panel further comprises a step of pivoting the one door panel and the other door panel about the first hinge plate.

14. The method of claim 12 wherein the step of pivoting the one door panel and the other door panel further comprises a step of pivoting the first support plate about the second support plate.

15. The method of claim 12 wherein the activating the lock mechanism further comprises of a step of activating a securing device to removably secure the lock mechanism in a closed position.

16. The method of claim 11 further comprising a step of removably covering the lock mechanism and preventing the lock mechanism from disengaging the second support plate.

17. The method of claim 11 further comprising a step of removably securing a securing cap over a latch lever, preventing a latch lever rotation and subsequent deactivating the lock mechanism and releasing the first hinge plate.

18. The method of claim 11 further comprising a step of removably securing a securing cap over a latch lever, preventing a latch lever rotation and removably retaining an engagement of the ratchet with the lock mechanism's latch plate.

19. The method of claim 11 wherein the activating the lock mechanism further comprises a step of removably engaging the lock mechanism latch lever with one or more ridges of the second support plate.

20. A system of pivotally connected door panels that form a panel door comprising:
(A) a plurality of door panels that are configured to form a panel door, wherein a respective door panel pivots about an adjacent door panel;
(B) a set of lockable door panel hinges, each lockable door panel hinge comprising a first hinge plate and a second hinge plate, the two hinge plates further configured to be removably connected together by a lock mechanism, the first hinge plate further forming a pivot mechanism that bifurcates the first hinge plate into a first support plate and a second support plate, the first support plate and second support plate pivoting about the pivot mechanism, the lock mechanism and pivoting mechanism being separate mechanisms;
wherein a first hinge plate attaches to the respective door panel and the second hinge plate attaches to the adjacent door panel, the second support plate removable engages the lock mechanism so that the respective door panel and the adjacent door panel pivots about each other and the pivot mechanism.
